(19) United States
(12) Patent Application Publication
(10) Pub. No.: US 2007/0111672 A1
(43) Pub. Date: May 17, 2007

(54) Vehicle-to-vehicle communication

(75) Inventors: Pierre-Yves Saintoyant, Aachen (DE); Petri Mahonen, Aachen (DE)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/273,031

(22) Filed: Nov. 14, 2005

(51) Int. Cl. G08G 1/00; H04B 1/38; H04B 1/034; H04Q 7/20

(52) U.S. Cl. 455/73; 340/902; 455/466; 455/99

(57) ABSTRACT

Various technologies and techniques are disclosed that allow passengers in one vehicle to communicate with passengers of another vehicle. Vehicles can have a computer, transceiver, and one or more antennae that enable vehicle-to-vehicle communications. The computer allows the user to select the particular direction, such as front or back, of the close proximity vehicle to communicate with. The communication is then transmitted using a transceiver and antenna of the first vehicle to an antenna and transceiver of the second vehicle.

### BACKGROUND

With an ever advancing world of technology, communication tools are available which allow us to communicate with each other over short and long distances. For example, we can communicate with others from remote locations, such as by landline telephone, cellular telephone, or email. Specific personal knowledge about the receiver, such as the receiver's telephone number or email address, is typically necessary in order to initiate a communication with them. Push-to-talk communications devices, such as traditional walkie-talkies, or newer variations that are integrated within cellular telephones, allow individuals to push a button and transmit a voice communication to someone on the receiving end with a similar device. In such cases, the particular phone number or phone identifier of the individual you want to communicate with must be known, or some agreed-upon frequency on which you will transmit messages must be known. Both of these scenarios typically require you to have some communication with the other individual ahead of time in order to obtain the telephone number or frequency number that will be used for the communication.

There are some situations where you may be driving a vehicle and would like to communicate with someone driving another vehicle near you. That individual may be someone you know, or they may be a total stranger. While that individual may be within visual range, you cannot typically communicate with them unless you know their cellular telephone number or some similar identifier to use for contacting them.

### SUMMARY

Described herein are various technologies and techniques that will allow for passengers in one vehicle to communicate with the passengers of another vehicle. As one non-limiting example, vehicles can have a computer, transceiver, and one or more antennae that enable vehicle-to-vehicle communications. Users in one vehicle can use the computer in their vehicle to select a close proximity vehicle to communicate with. For example, the computer can have one or more buttons to allow the user to select the particular direction, such as front or back, that represents the close proximity vehicle with which the user wants to communicate. The communication can be a voice communication, or a text message. For a text message, the user inputs the message using an input device.

The communication is then transmitted using a transceiver and an antenna of the first vehicle to an antenna and transceiver of the second vehicle. For example, each vehicle can have antennae on the front and back, to allow for communications with a vehicle in front and a vehicle in back. Other antennae variations are also possible. Communications can be transmitted without permission of the receiver, or the receiver can selectively determine which communications to accept.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of parts of a vehicle communication system.

FIG. 2 is a diagrammatic view of a computer system of one implementation of the system of FIG. 1.

FIG. 3 is a high-level process flow diagram for one implementation of the system of FIGS. 1 and 2.

FIG. 4 is a process flow diagram for one implementation of the system of FIGS. 1 and 2 illustrating the stages involved in sending and receiving a communication from one vehicle to another.

FIG. 5 is a process flow diagram for one implementation of the system of FIGS. 1 and 2 illustrating the stages involved in selecting the type of communication to send to the other vehicle.

FIG. 6 is a simulated screen for one implementation of the system of FIGS. 1 and 2 that illustrates selecting a particular vehicle to communicate with.

FIG. 7 is a simulated screen for one implementation of the system of FIGS. 1 and 2 that illustrates receiving an incoming audio communication.

FIG. 8 is a simulated screen for one implementation of the system of FIGS. 1 and 2 that illustrates some options for ignoring the communication.

FIG. 9 is a simulated screen for one implementation of the system of FIGS. 1 and 2 that illustrates entering a text message.

FIG. 10 is a simulated screen for one implementation of the system of FIGS. 1 and 2 that illustrates receiving a text message.

FIG. 11 is a simulated screen for one implementation of the system of FIGS. 1 and 2 that illustrates reviewing a received text message.

FIG. 12 is a simulated screen for one implementation of the system of FIGS. 1 and 2 that illustrates sending a canned text message.

FIG. 13 is a simulated screen for one implementation of the system of FIGS. 1 and 2 that illustrates various setup parameters that can be modified.

FIG. 14 is a simulated screen for one implementation of the system of FIGS. 1 and 2 that illustrates another variation for selecting a particular vehicle to communicate with.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a communication system that allows communication between vehicles. In one implementation, the system is operational with numerous general purpose or special purpose vehicles or transportation systems. Examples of well known vehicles, transportation systems, environments, and/or configurations that may be suitable for use with the system include, but are not limited to, personal automobiles, trucks, motorcycles, scooters, busses, trains, planes and any other transportation environments that include any of the above systems or modes, and the like.

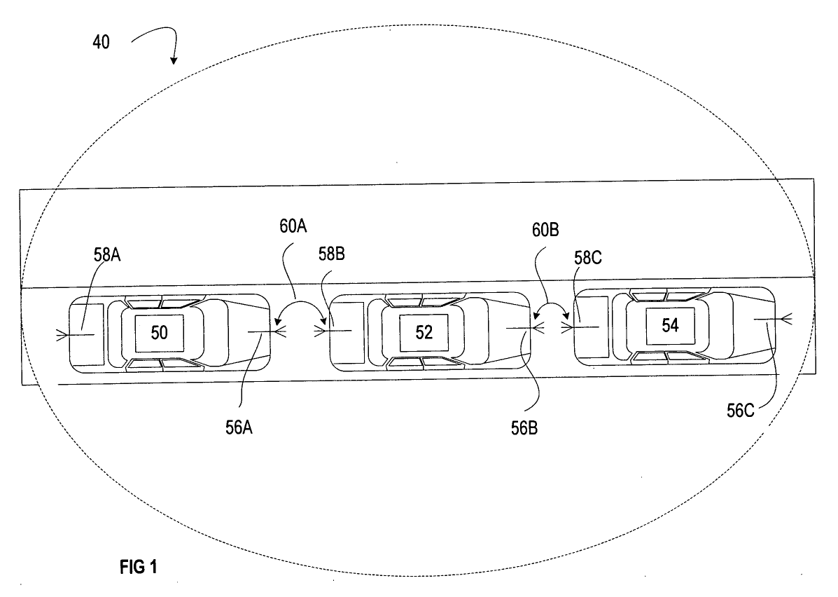

As shown in FIG. 1, in one implementation, each vehicle (50, 52, and 54, respectively) of communication system 40 has both a front antenna (56A, 56B, and 56C, respectively) and a rear antenna (58A, 58B, and 58C, respectively) attached to it that are used to receive and transmit radio frequency signals. One non-limiting example of a type of antenna that can be used with communication system 40 includes a high gain antenna with a small physical size and strong directivity lobe, such as one made by SkyCross. Such directive antennae provide clear and strong directivity for messages, such as to the front and rear of the vehicle. Another non-limiting example of a type of antenna that can be used includes a beam forming adaptive antenna, which is available from several manufacturers. Numerous other types of antenna could also be used to enable receiving and transmitting radio frequency signals between vehicles, such as antennae without strong directivity. The coverage angle of each antenna can vary according to the type of coverage desired. As one non-limiting example, the lobe of the antennae can be about 20-35 degrees in order to provide strong directivity towards the front and rear of the particular vehicle.

Front antenna 56A of vehicle 50 is able to communicate with rear antenna 58B of vehicle 52 over radio frequency pathway 60A. Similarly, front antenna 56B of vehicle 52 is able to communicate with rear antenna 58C of vehicle 54 over radio frequency pathway 60B. While three vehicles (50, 52, and 54) are shown for the illustration purposes, more or fewer can be used with communication system 40. Furthermore, while each of vehicles 50, 52, and 54 are shown to have a front antenna (56A, 56B, and 56C, respectively) and a rear antenna (58A, 58B, and 58C, respectively), it will be appreciated that numerous other variations are also possible that include more or fewer antennae. For the sake of simplicity, front antenna 56A, 56B, and 56C will be referred to collectively as front antennae 56. Furthermore, rear antenna 58A, 58B, and 58C will be referred to collectively as rear antennae 58.

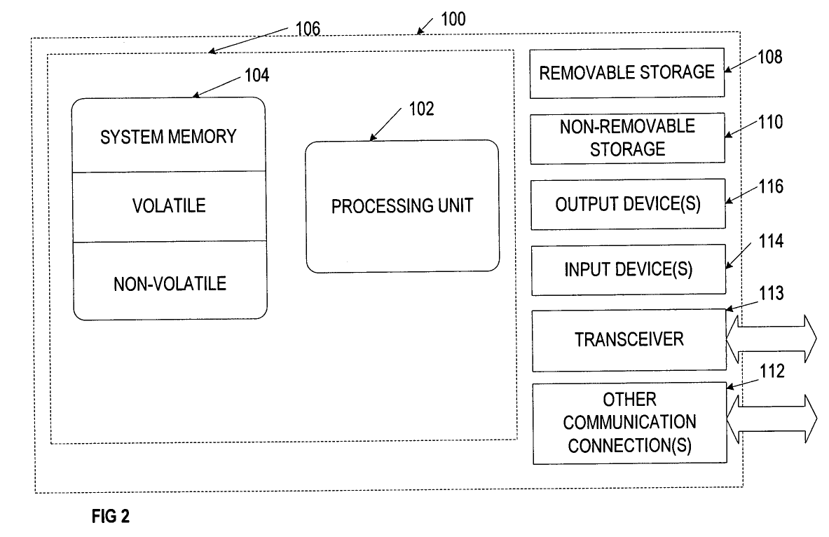

With reference to FIG. 2, an exemplary computer system to use for implementing one or more parts of communication system 40 includes a computing device, such as computing device 100. In one implementation, computing device 100 is used in one or more of vehicles 50, 52, and/or 54 for providing a user interface for communication system 40. Computing device 100 can be coupled within the respective vehicle (50, 52, or 54), such as part of the vehicle's on-board computer system. Alternatively or additionally, computing device 100 can be portable and removable from the respective vehicle (50, 52, or 54). Alternatively or additionally, computing device 100 is coupled to some of vehicles (50, 52, and 54) and removable in others.

In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 2 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 2 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

In one implementation, device 100 includes digital radio transceiver 113 that allows device 100 to transmit communications by radio frequency to one or more of front antennae 56 and/or rear antennae 58. As one non-limiting example, transceiver 113 can be a 2.4 GHz ISM band chipset designed for WiFi (IEEE 802.11 usage). Furthermore, in one implementation, the transmission power of transceiver 113 is limited so that communications can be received only within limited coverage areas. In one implementation, this provides a strong locality for the communication so only vehicles within close proximity are detected, and can increase the spectral efficiency of communication system 40. Alternatively or additionally, a capability can be included in device 100 to allow a user to adjust the transmission power of transceiver 1113, so as to control the basic coverage area of the communication capability, such as to vehicles instead of or in addition to front and rear vehicles. Other frequency areas, modulations, and transceiver technologies could be used instead of or in addition to those described in the illustrative examples.

In one implementation, the packet header of each communication is encoded with special bit-stream or multicast addresses to make it clear that the message is sent by the communication system 40. In such a scenario, the transceivers 113 in the vehicles are scanning continuously on the specified sub-channels and then filter in those messages that were sent by communication system 40. Other variations for detecting communications are also possible.

In one implementation, communication system 40 and computing device 100 are operable to build encrypted connections in such a way that participants can agree on secret keys, and then transmit audio and/or text messages using encryption based on the secret keys.

Alternatively or additionally to transceiver 113, device 100 may contain other communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have input device(s) 114 such as keyboard, mouse, pen, voice input device, touch input device, etc. Output device(s) 116 such as a display, speakers, printer, etc. may also be included. These devices are well known in the art and need not be discussed at length here. Alternatively or additionally, speakers can be part of the vehicle audio system.

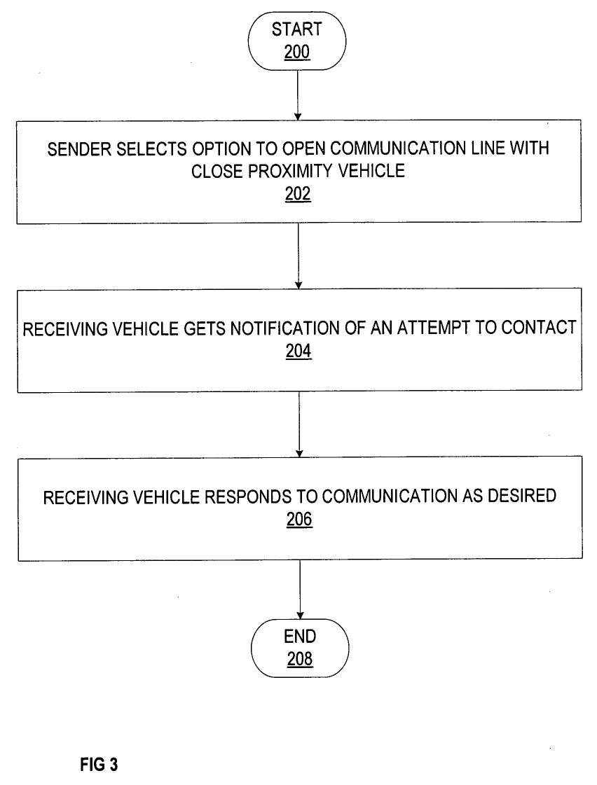

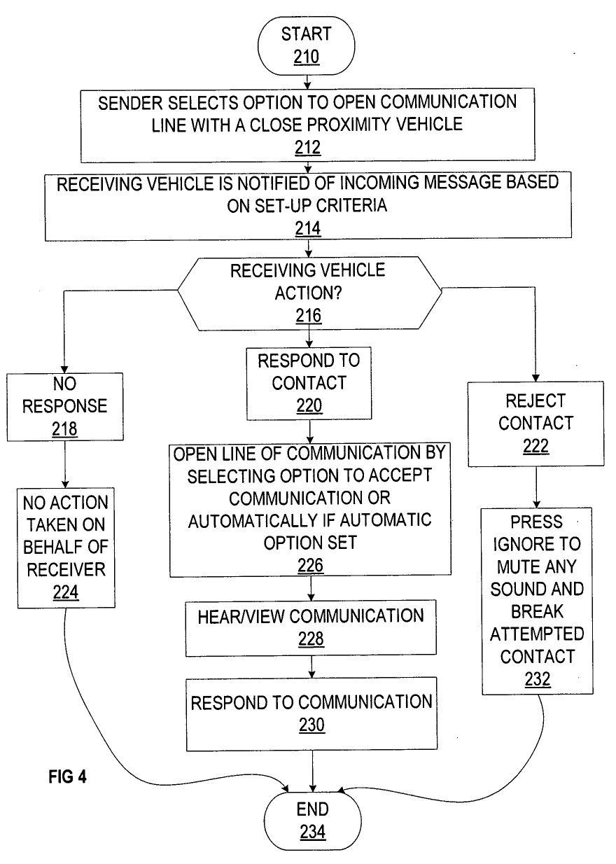

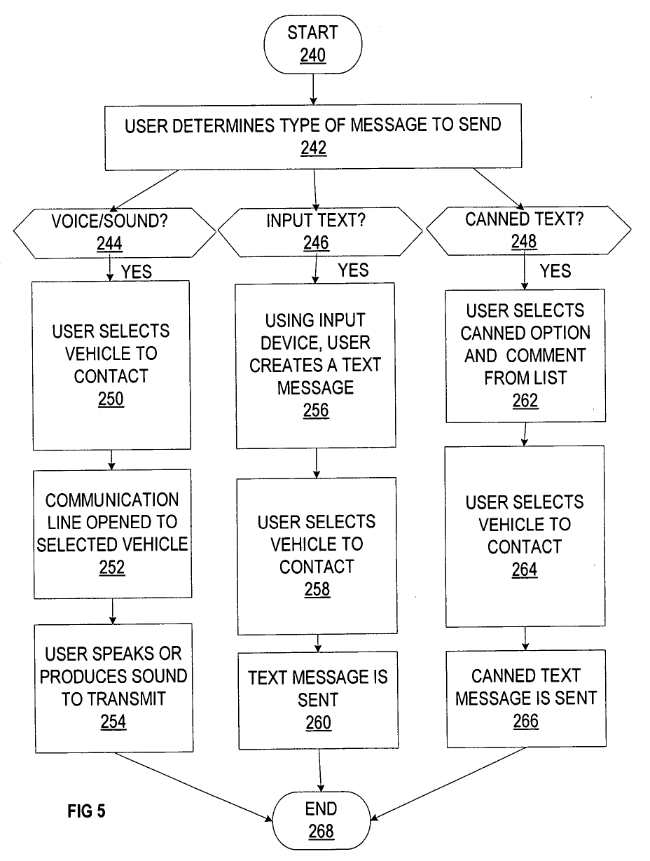

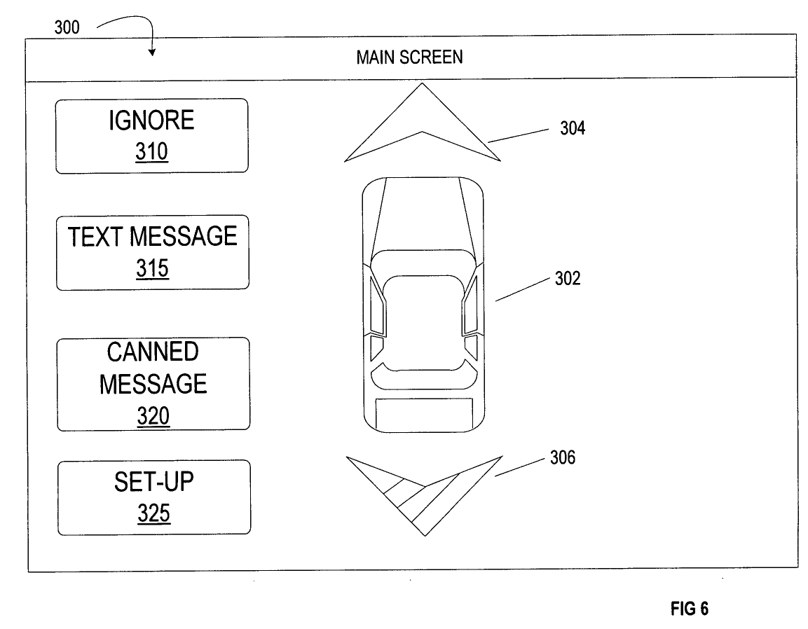

Turning now to FIGS. 3-5 with continued reference to FIGS. 1-2, the stages for implementing one or more implementations of communication system 40 are described in further detail. FIG. 3 is a high level process flow diagram for communication system 40. In one form, the process of FIG. 3 is at least partially implemented in the operating logic of computing device 100. The process begins at start point 200 with the sender selecting an option to open a communication line with a close proximity vehicle (stage 202), such as one in the front or the rear. The receiving vehicle gets notification of an attempt to contact (stage 204). The receiving vehicle responds to the communication as desired (stage 206). The process then ends at end point 208. These stages will be described in further detail in the flow diagrams of FIGS. 4 and 5 and the simulated screens in FIG. 6-14.

FIG. 4 illustrates the stages involved in sending and receiving a communication from one vehicle to another. In one form, the process of FIG. 4 is at least partially implemented in the operating logic of computing device 100. The process begins at start point 210 with the sender selecting an option to open a communication line with a close proximity vehicle (stage 212). The receiving vehicle is notified of an incoming communication based on the set-up criteria (stage 214). The receiving vehicle can then take one or more actions (decision point 216), such as no response (stage 218), respond to contact (stage 220), or reject contact (stage 222). If the user in the receiving vehicle wishes to provide no response (stage 218), then no action is taken by the receiving user (stage 224). Two-way communication does not commence between the two vehicles in such a scenario.

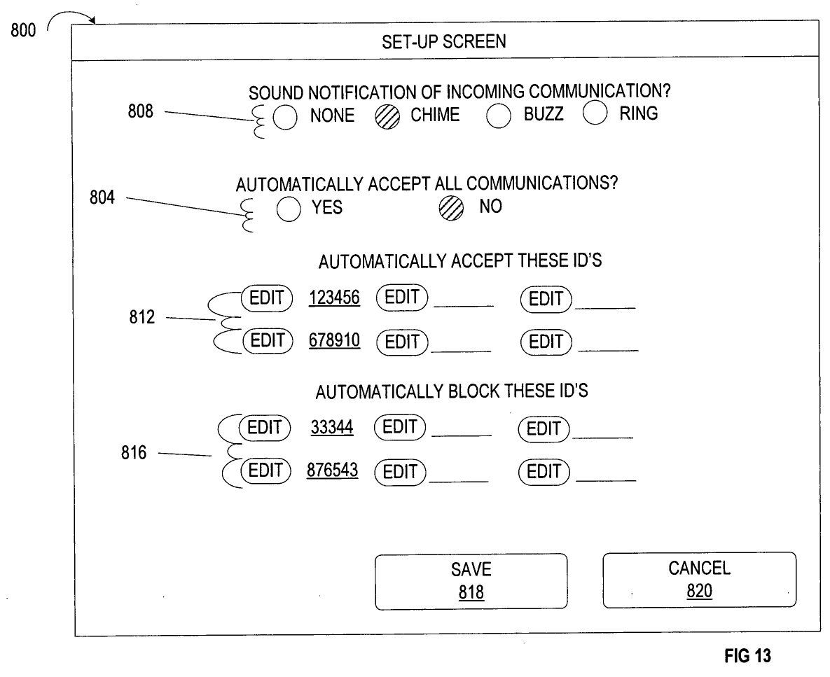

If the user in the receiving vehicle wishes to respond to the communication (stage 220), then he/she opens a line of communication by selecting an option to accept communication from the particular vehicle (stage 226). If an automatically connect option is set for the vehicle (see FIG. 13), then the communication can be automatically connected without action by the receiving user (stage 226). The receiving user then hears and/or views the communication (stage 228) and can respond to the communication as desired (stage 230). If the receiving user wishes to reject the communication, then he/she selects an ignore option to mute any sound and break the attempted contact (stage 232). The process then ends at end point 234.

FIG. 5 illustrates the stages involved in selecting the type of communication to send to the other vehicle. In one form, the process of FIG. 5 is at least partially implemented in the operating logic of computing device 100. The process begins at start point 240 with the user determining the type of message to send (stage 242). If the user wishes to communicate with the other vehicle by voice/sound (decision point 244), then the user selects the option representing the vehicle to contact (stage 250). A communication line is opened to the selected vehicle (stage 252). The user speaks and/or produces the sound to transmit (stage 254). If the user wishes to send a text message (decision point 246), then using input device 114, the user creates a text message (stage 256). The user selects a vehicle to contact (stage 258) and the text message is sent (stage 260). If the user wishes to send a canned text message (decision point 248), then the user selects the canned text option and then selects a desired canned comment from a list (stage 262). The user selects a vehicle to contact (stage 264), and the canned text message is sent (stage 266). The process then ends at end point 268.

Turning now to FIGS. 6-14, simulated screens are shown to illustrate the stages described in FIGS. 3-5 in further detail. These screens can be displayed to users in a particular vehicle on output device(s) 116. Furthermore, These screens can receive input from users in a particular vehicle from input device(s) 114. Screen 300 of FIG. 6 is a simulated screen for one implementation of the system of FIGS. 1 and 2 that illustrates a main screen for selecting a particular vehicle to communicate with. Screen 300 includes a representation of the user's vehicle 302, a front vehicle option 304, and a rear vehicle option 306. Screen 300 also includes ignore option 310, text message option 315, canned message 320, and set-up option 325, which are discussed in further detail in later sections.

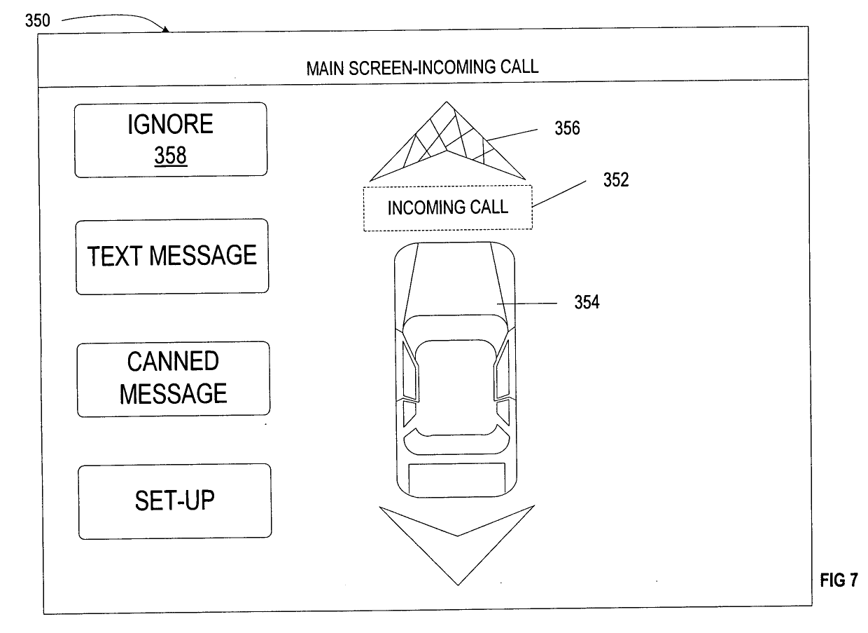

Some hypothetical scenarios will now be described to illustrate how two vehicles can communicate using communication system 40. Starting with screen 300 on FIG. 6, and with continued reference to FIGS. 1-5, the user in the first vehicle selects rear vehicle option 306 to initiate an audio communication with the vehicle behind (stage 212 of FIG. 4 and stage 250 of FIG. 5). Rear vehicle option 306 is shown highlighted to indicate it is being selected. Turning now to FIG. 7, screen 350 is shown which illustrates the user interface shown on output device 116 of the second user's vehicle (i.e. the one in the rear of the first vehicle). Since this is an incoming audio message, message indicator 352 indicates that it is an incoming call (stage 214). Graphical representation of the second user's vehicle 354 is shown for perspective, and the front vehicle option 356 is flashing to notify the user of the incoming communication. Depending on the set-up options that the user has specified, one or more sounds can alternatively or additionally be emitted to audibly indicate there is an incoming communication. If the user wishes to respond to the communication by voice (stage 220), then he/she selects front vehicle option 356 (stage 226) and the two-way communication line is opened (stage 228) so that the user can respond to the communication (stage 230). In such a scenario, the voice communication is transmitted between the vehicles using the respective transceiver 113 and the respective antennae 56 or 58 of each vehicle.

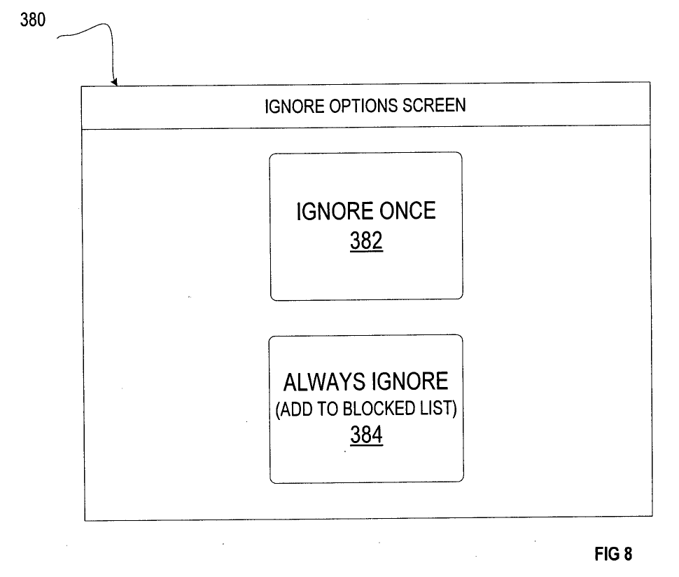

If the user wishes to ignore the voice communication (stage 222) and break the connection, he/she can select ignore option 358 (stage 232). In one implementation, a screen as shown in FIG. 8 is then displayed to ask the user to select either an ignore once option 382 to specify whether to ignore this vehicle just this one time or an always ignore option 384 to specify whether to always ignore the vehicle and add it to the blocked list 384.

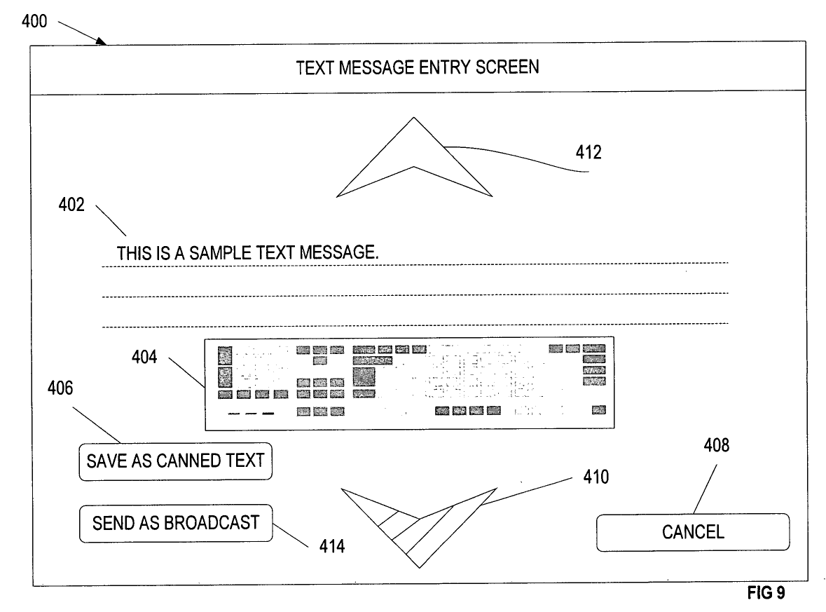

A hypothetical example will now be described to illustrate how to send and receive text communications using communication system 40 and computing device 100. Returning to FIG. 7, suppose that the user selected text message option 315 (stage 246). Turning now to FIG. 9, a text message entry screen 400 is then displayed to allow the user to enter the desired text message (stage 256). Text message entry screen 400 includes text input area 402 and touch-screen keyboard 404. Keyboard 404 is a non-limiting example of input device(s) 114 that can be used to input the desired text into text area 402. Other input device(s) 114 could also be used instead of or in addition to on-screen keyboard 404.

The user can select the save as canned text option 406 to save the entered message as canned text for easy re-use later. The user can select the send as broadcast option 414 to send the specified text message to all surrounding vehicles within a certain range. An example of when a broadcast message might be used includes an emergency scenario where the user wants someone to call emergency response (e.g. 911) on their behalf. The user can select cancel option 408 to cancel out of the text message entry screen and be returned to the main screen 300 of FIG. 6.

After entering the desired text message into text area 402 (stage 256), the user can select one of options 410 or 412 to specify which vehicle should receive the text message (stage 258). In this scenario, suppose the user in the first vehicle wishes to send the text message to the vehicle in the rear. The user selects the rear vehicle option 410, which is shown highlighted to illustrate it is being selected. The text message is then sent to the selected vehicle (stage 260).

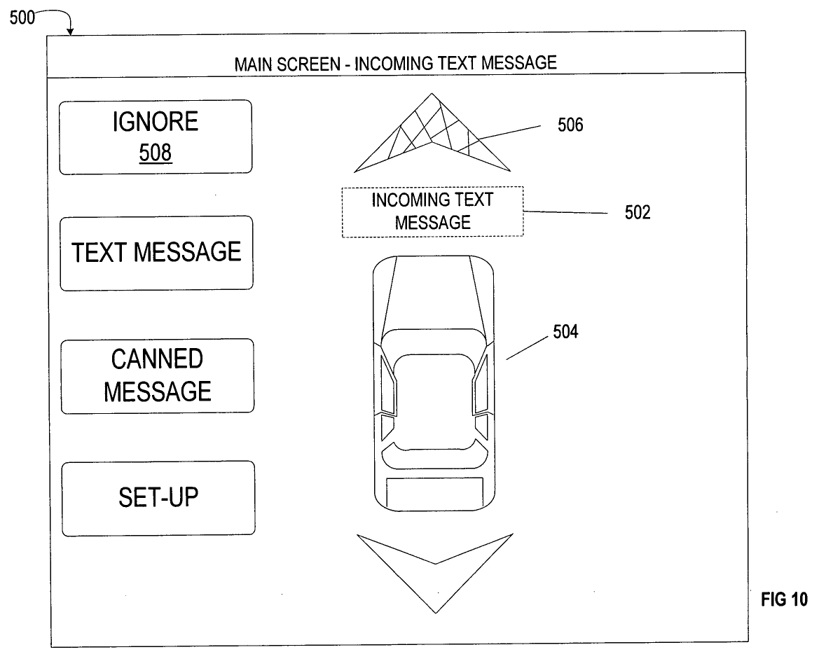

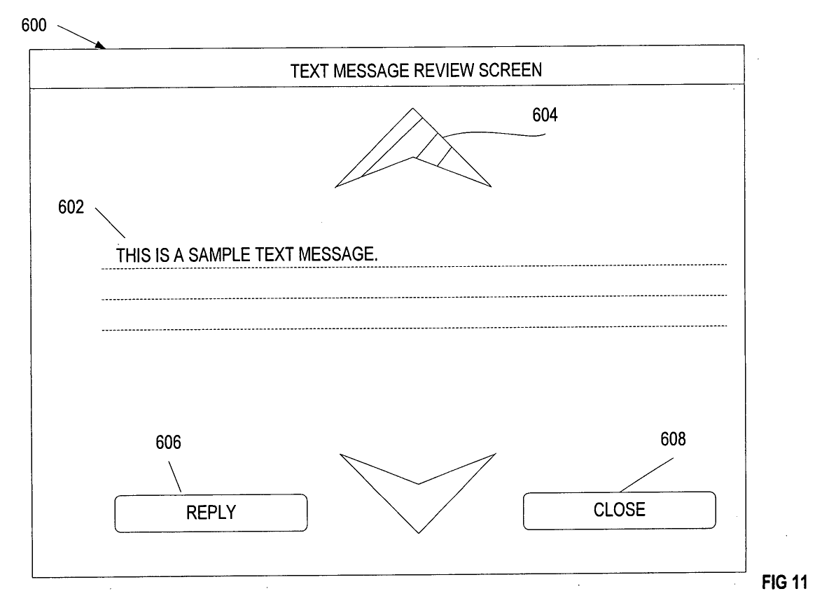

Turning now to FIG. 10, simulated screen 500 illustrates the screen as displayed on the rear vehicle to illustrate that there is an incoming text message. Again, a graphic representation of the user's own vehicle is shown 504, plus a visual indicator to illustrate there is an incoming text message 502. The front vehicle option is also flashing 506 to indicate that the vehicle in front is the one sending the text message (stage 214). If the user has the automatically accept communications option enabled, the text message is displayed automatically, as shown on FIG. 11. If the automatically accept communications option is not enabled, the user can select the front vehicle option 506 to accept the text message (stage 226). The text message is displayed (stage 228), as shown screen 600 of FIG. 11, along with an indicator 604 to illustrate which vehicle the text message came from. Screen 600 includes a reply option 606 to allow the user in the second vehicle to transmit a text message response back to the first vehicle (stage 230). Close option 608 closes the screen and returns the user to the main screen of FIG. 6.

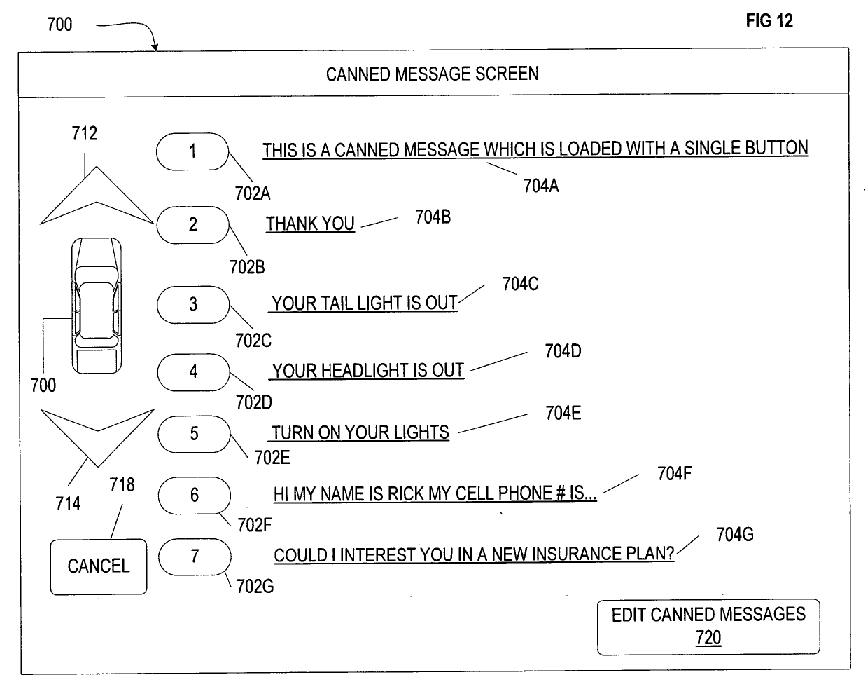

Returning to FIG. 6, if the user wishes to send a canned text message, he/she selects canned message option 320. A screen as shown in FIG. 12 is then displayed. Canned message screen 700 allows the user to select a message from a list of pre-defined messages. These messages can be supplied by the system and/or specified by the user. The user can select one of option buttons 702A, 702B, 702C, 702D, 702E, 702F, or 702G (collectively options 702) in order to choose a particular one of canned messages 704A, 704B, 704C, 704D, 704E, 704F, or 704G, respectively (collectively canned messages 704). After selecting one of options 702, the user can then select front vehicle option 712 or rear vehicle option 714 to specify which vehicle with respect to the user's current vehicle 700 to send the canned message to. The message is then transmitted to the selected vehicle using the respective transceiver 113 and the respective antennae 56 or 58 of each vehicle. The user can select cancel option 718 to return to the main screen of FIG. 6. The user can select edit canned messages option 720 to edit the list of canned messages that are available.

Returning to FIG. 6, if the user selects set-up option 325, then a screen as shown in FIG. 13 is then displayed. Set-up screen 800 allows the user to customize one or more of the options that control how computing device 100 will operate with communication system 40. For example, the user can select one of sound options 808 to specify what type of sound notification, if any, to receive when there is an incoming communication. The user can select automatic option 804 to specify whether or not to accept incoming communications automatically. The user edits the list of vehicles that are automatically accepted using one of edit options 812. These vehicles can be automatically connected even if the automatic option 804 is set to no. The user can also edit the list of vehicles that are automatically blocked using one of edit options 816. These blocked vehicles were added when the user selected the always ignore option 384 on FIG. 8.

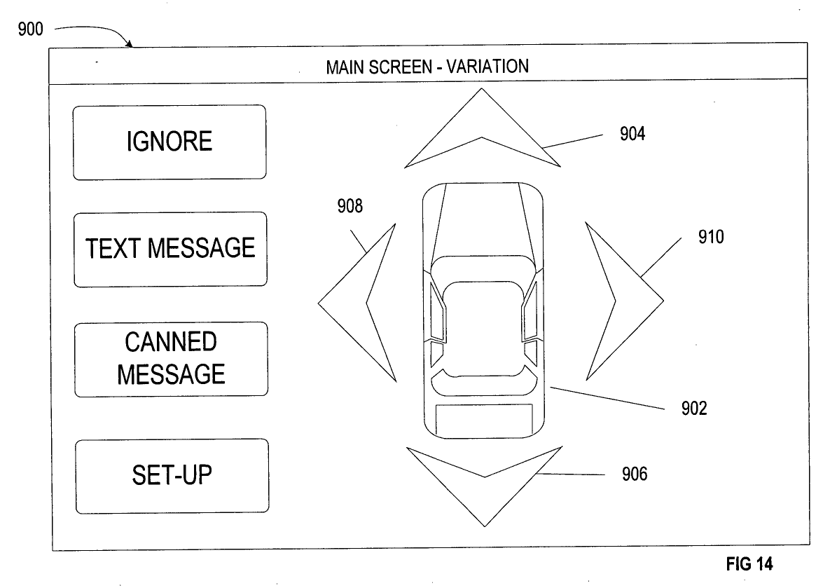

Turning now to FIG. 14, a simulated screen 900 is shown that illustrates a variation of main screen 300. Screen 900 provides the ability to communicate with four vehicles around the current vehicle 902. For example, screen 900 includes front vehicle option 904, rear vehicle option 906, left vehicle option 908, and right vehicle option 910. While example screens illustrated communicating with front and rear vehicles, and left and right vehicles, other variations and directions are also possible. Furthermore, numerous other ways for selecting a vehicle to communicate with could also be used instead of or in addition to the selection options described in these hypothetical examples.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
receiving input from a first user in a first vehicle to select a second vehicle to communicate with;
receiving a communication from the first user; and
sending a signal to a digital transceiver so that the digital transceiver can communicate with a radio frequency antenna to transmit the communication to the second vehicle.

2. The computer-readable medium of claim 1, wherein the receiving the communication step further comprises the step of:
receiving an audio communication from the first user.

3. The computer-readable medium of claim 1, wherein the receiving the communication step further comprises the step of:
receiving a text message communication from the first user.

4. A system for facilitating communications between vehicles comprising:
an output device operable to display a user interface to a user in a first vehicle;
a first input device operable to receive input from the user in the first vehicle to select a second vehicle to communicate with;
a second input device operable to receive a specific communication from the user that is directed to the second vehicle;
at least one antenna operable to be coupled to the first vehicle;
a digital transceiver operable to be coupled to the first vehicle, and further operable to receive the specific communication from the second input device and transmit the specific communication to at least one antenna; and
wherein the at least one antenna is further operable to forward the communication to the second vehicle.

5. The system of claim 4 wherein the antenna is a radio frequency antenna.

6. The system of claim 4, wherein the at least one antenna includes a first antenna and a second antenna, wherein the first antenna is operable to communicate with a front vehicle located in a front position, and wherein the second antenna is operable to communicate with a rear vehicle located in rear position.

7. The system of claim 4, wherein the first input device is a touch-screen.

8. The system of claim 4, wherein the first input device is a keyboard.

9. The system of claim 4, wherein the second input device is at least one speaker.

10. The system of claim 4, wherein the second input device is operable to receive an audible sound as the specific communication.

11. The system of claim 4, wherein the second input device is operable to receive a text message as the specific communication.

12. The system of claim 4, wherein the digital transceiver supports the WiFi 802.11 protocol.

13. The system of claim 4, wherein the display device and the first input device are part of an on-board vehicle computer system.

14. The system of claim 4, wherein the display device and the first input device are part of a portable computer system that can be removed from the first vehicle.

15. The system of claim 4, wherein the second input device is a speaker that is able to receive audio input and produce audio output.

16. A method for communicating between vehicles comprising the steps of:
in a first vehicle, receiving a notice of an incoming communication that was sent from a second vehicle;
receiving a selection from a first user of an option to accept the incoming communication;
receiving the incoming communication from the second vehicle through an antenna and a transceiver coupled to the first vehicle;
receiving a response to the incoming communication from the first user; and
transmitting the response from the first user to the second vehicle.

17. The method of claim 16, wherein the incoming communication is an audio communication.

18. The method of claim 16, wherein the incoming communication is a text message communication.

19. The method of claim 16, wherein the first vehicle has a front antenna mounted to the front and a rear antenna mounted to the rear.

20. A computer-readable medium having computer-executable instructions for causing a computer to perform the steps recited in claim 16.
